(19) United States
(12) Patent Application Publication
(10) Pub. No.: US 2009/0288079 A1
(43) Pub. Date: Nov. 19, 2009

(54) AUTOMATIC INSTALLATION OF A SOFTWARE PRODUCT ON A DEVICE

(75) Inventors: Mark Zuber, Duvall, WA (US); Christopher Vander Mey, Seattle, WA (US); Shankar Ganesh, Bellevue, WA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/120,133

(22) Filed: May 13, 2008

(51) Int. Cl. G06F 9/445

(52) U.S. Cl. 717/176

(57) ABSTRACT

Methods, systems, and apparatus, including medium-encoded computer program products, for installing software include receiving a request to install a software product on a device and identifying the software product and the source of the software product based on the request. A message, which includes data identifying the software product and the source of the software product, is transmitted to a remote update device. An authorization message is received from the remote update device indicating whether the source of the software product is authorized to provide the software product. If the authorization message indicates that the source of the software product is authorized to provide the software product, the software product is automatically installed on the device.

### TECHNICAL FIELD

This description relates to installing one or more software products on a remote device.

### BACKGROUND

When a user desires to install a software application or software application updates on a computer, the process typically involves a long series of prompts to which the user must respond in order to complete the installation process. Some of these steps are driven by the need for security and authorization that typically need to be addressed with each software installation request. Such issues may require action by a systems administrator or other high level security agent. Installed software applications may require maintenance in the form of software updates in order to provide additional features, to fix bugs, to increase robustness, to block security holes, or to address other issues. Online downloads of these updates, as well as the download of software applications generally have grown in popularity. Users often employ a web browser installed on their computers to access the sources of software applications and download these software applications.

### SUMMARY

Systems and methods can be implemented to automatically install software products while ensuring authorized installation of the software product.

In one general aspect, a request to install a software product on a device is received. Based on the request, the software product and the source of the software product are identified. A message including data identifying the software product and the source of the software product is transmitted to a remote update device. In response to the message, an authorization message is received from the remote update device indicating whether the source of the software product is authorized to provide the software product. If the authorization message indicates that the source of the software product is authorized to provide the software product, the software product is automatically installed on the device.

Implementations can include one or more of the following features. An error message can be transmitted to the source of the software product if the authorization message indicates that the source of the software product is not authorized to provide the software product. The error message can indicate that the installation of the software product failed. The request to install a software product can comprise installation instructions. Alternate installation instructions for installing a software product on a device may be received from the source of the request to install a software product in response to the error message. The alternate installation instructions can include displaying at least one prompt to a user and receiving at least one user selection in response to the user prompt.

The software product is automatically installed in accordance with the installation instructions. A notification message is transmitted to a source of the installation instructions indicating that an installation assistant plug-in is installed on the device prior to receiving the request to install the software product. The software product can be an update of software already installed on the device. The software product is installed on the device by an installation assistant module. A software license update message is received from the remote update device, indicating that an updated end user license agreement is needed prior to installation of the software product, and a user acceptance of the updated end user license agreement may be received prior to installing the software product. An authorization to install the software product can be received from the user through a web browser on the device.

Received installation instructions are processed to produce a processed installation instruction set. The received installation instructions received through a browser application to a module separate from the browser application are detected. The received installation instructions are processed to install the software product. Permission is received from a user through a user interface to install a software product.

In another general aspect there is at least one client device. A remote application server is adapted to transmit installation instructions for installation of the software product to the at least one client device and further adapted to transmit software product data to the at least one client device. At least one other remote application server is responsible for transmitting software product data and comprises a remote download server. At least one update server is adapted to receive an authorization query from the at least one client device, process the authorization query, and transmit an authorization message to the at least one client device.

Implementations may include one or more of the following features. The remote download server is distinct from the remote application server responsible for transmitting the installation instructions. At least one update server is adapted to process the authorization query to determine whether the remote download server is authorized to provide the software product to the client device. At least one update server is adapted to transmit an authorization message to the at least one client device indicating that the remote download server is authorized to provide the software product to the at least one client device. At least one update server is adapted to transmit an authorization message to the at least one client device indicating that the remote download server is authorized to provide the software product to the at least one client device.

At least one remote application server can be a web server. At least one client device comprises an installation assistant module, wherein the installation assistant module is adapted to install the software product on the at least one client device. At least one client device comprises an installation assistant plug-in, wherein the installation assistant plug-in is adapted to receive and process the installation instructions to produce a processed installation instruction set. The installation assistant module is adapted to receive and process the processed installation instruction set. At least one of the installation assistant module or the installation assistant plug-in is adapted to operate with a web browser installed on the at least one client device. At least one client device comprises a user authorization module, wherein the user authorization module is adapted to receive permission from a user to install the software product on the at least one client device.

In another general aspect, an authentication query is received from a client device. The authentication query is sent from the client device in response to an installation request received by the client device from a remote download device and identifies an installation request and a source of the installation request. The authentication query is processed to determine whether the remote download device is authorized to provide a software product identified in the installation request to the client device. An authorization status message is transmitted to the client device, indicating whether the remote download device is authorized to provide the software product to the client device.

Implementations may include one or more of the following features. Installation request identification data is interpreted to identify at least one of the software product or the source of the software product. The source of the software product can be a web server distinct from the remote download device. A database is consulted for an indication that the source of the software product is authorized to provide at least one application file to the client device for use in installing the software product on the client device. The authentication query can be installation instructions corresponding to the software product, wherein at least one of the software product or the source of the software product can be identified from the installation instructions. It can be determined whether the client device is authorized to execute the installation instructions. A network address is referenced corresponding to the source of the software product. A software license update associated with the software product is identified and transmitted to the client device. The source of at least one installation file corresponding to the software product is identified from the authentication query. The software product is identified from the authentication query. A list of authorized installation file sources is consulted for the identification of the source of at least one installation file corresponding to the software product. An authorization status message is generated indicating that the remote application device is authorized to provide the software product to the client device if the remote application device is identified on the list of authorized application devices. The remote application device is identified. A received installation request is analyzed. It can be determined whether the remote application device is authorized to provide the received installation request to the client device. A database is consulted for the identification of the software product and verify that the remote application device is authorized to provide a software product corresponding to the received installation request.

### DESCRIPTION OF DRAWINGS

FIG. 1A is a block diagram illustrating an example configuration of an automatic installation system for software products.

FIG. 1B is a block diagram illustrating an example modular configuration of an automatic installation system for software products.

FIG. 2 is a flow diagram illustrating an example of the interaction of components in one configuration of an automatic installation system for software products.

FIG. 3 is a flow diagram of an example process for automatically installing a software product on a computer device.

FIG. 4 is a flow diagram of an example process for processing an authorization query by an update device.

Like reference symbols in the various drawings indicate like elements.

### DETAILED DESCRIPTION

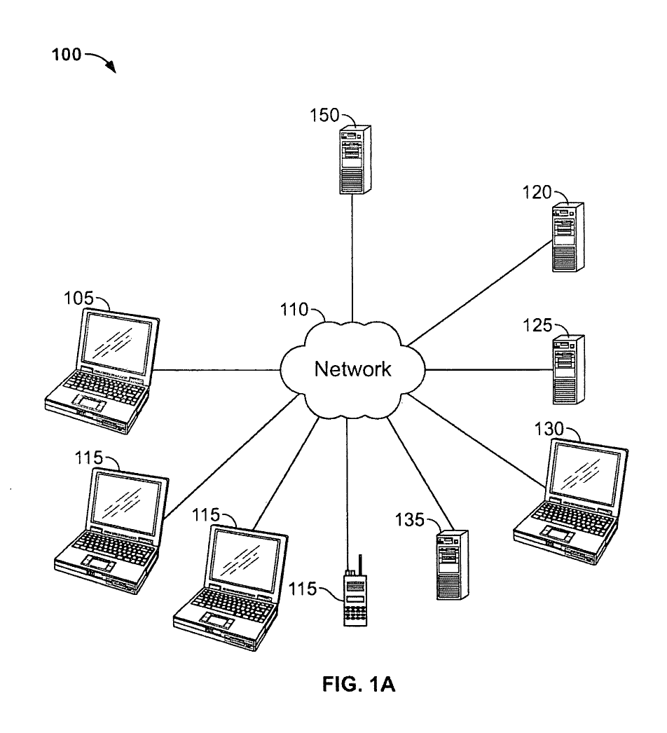

As shown in FIG. 1A, a system 100 for use in automatically installing software products, including software product updates, is provided. A client device 105 can communicate with one or more remote servers across a network 110. The network can be any electronic communications network known in the art, for example a LAN or the internet. Additional client devices 115 may also be capable of connecting to the network. Client devices may connect to the network using known communication techniques, for example via a hardwire (e.g., Ethernet) or a wireless (e.g., IEEE 802.11b, WiMAX, etc.) connection. Remote computer devices 120, 125, 130, 135 are also capable of communicating across the network 110, including communicatively coupling with client devices 105, 115 through the network 110. One or more of the client devices 105, 115 may also be capable of communicating with a remote computer device designated as a remote update device 150. The remote update device 150 may be capable of fielding and communicating responses to queries from one or more of the client devices 105, 115 relating to various aspects of installing software products on a client device. Communications between the client devices 105, 115, remote computer devices 120, 125, 130, 135, and the remote update device 150 may be conducted using any suitable protocols, for example, the TCP/IP model. Remote computer devices may be implemented as computer servers or computer server systems.

FIG. 1B shows a modular representation of one possible implementation of the system illustrated in FIG. 1A. An installation assistant 140 is installed on a client device 105. The installation assistant 140 may be one or more software components installed on a client device 105 that are capable of managing the installation of at least one software product on the client device. The installation assistant 140 may be capable of managing the installation of several distinct software products, including products that represent updates of software products already installed on the client device 105. In some implementations, the installation assistant 140 may manage the installation of all software products on a given client device 105. Alternatively, the installation assistant 140 may be responsible only for the installation of a discrete number of software products. Additionally, the installation assistant 140 may either be a stand-alone application, or integrated with a web browser, virtual machine, or any other implementation compatible with the device 105 or the device's operating system.

In some implementations, an installation assistant 140 installed and running on a device 105 may consist of three major parts: (1) a runtime component which may handle the core update and install services; (2) a web browser control (e,g., ActiveX for Internet Explorer) which may allow web pages and web-based applications to interface with the installation assistant 140; and (3) a graphical user interface layer which may provide progress and feedback to the user during installation, updates, or any other services provided by the installation assistant 140.

The installation assistant 140 may provide installation of software products by executing binary installation instructions passed to it. The installation instructions may be passed and received through a variety of sources. For example, the instructions may be delivered to the device via a portable data memory device, such as a thumbdrive, portable hard drive, CD, DVD, or other memory means known in the art. The instructions might also be provided over a closed, private network from another computer or server connected to the network, or provided from a server or other computing device over the internet or other large scale computer network. In connection with installation instructions received by the installation assistant 140, the installation assistant may then receive and install binary files corresponding to the software product on the device 105. Installation instructions, or other binary files corresponding to the software product, may comprise, for example, a software-product-specific installation stub. The installation assistant 140 may then invoke the installation stub instrumentality to complete the installation of the related software product. As another example, installation instructions could point the installation assistant 140 to the URL of a remote download server 135, from which binary files relating to the installation of a software product are to be downloaded and then installed on the client device 105.

FIG. 1B also shows an installation assistant plug-in 145 installed on the device 105 in some implementations. The installation assistant plug-in 145 may be installed to run continuously during the runtime of a supervising program, such as a web browser or the device operating system. Some implementations of the installation assistant 140 may be designed to run only in connection with the installation of a software product on the device, whether it be the actual process of installing a software product, the receipt of a request to install a software product on the device, or the handling of installation instructions or other tasks related to the installation of software products. The plug-in 145 may be designed to run continuously, even when the installation assistant 140 is idle. Additionally, the plug-in 145 may be designed to communicate with the installation assistant 140.

In one example, the plug-in 145 may be embedded in the client device's 105 web browser 142. The plug-in 145 may be designed to route messages related to the installation of software products to the installation assistant 140. The messages may be received by the device via TCP/IP communications from remote web servers 120, 125, 130, 135. Here, the plug-in 145 may be capable of accepting arbitrary messages from arbitrary sources accessed through the web browser. In some examples, the plug-in 145 serves as a router for messages intended to be handled by the installation assistant 140. To accomplish this the plug-in 145 may, for example, store and execute logic instructions for recognizing messages, such as installation instructions, that should be relayed to the installation assistant 140. Alternatively, the routing functionality of the plug-in may be simplified in other implementations. For example, in order for a web server to send a message or specific type of message to the installation assistant 140, the web server 120 may be required to specifically address the message for routing by the plug-in 145. This may be accomplished by web servers 120, 125, 130, 135, accessed by the web browser, querying the device 105 regarding the installation of a particular installation assistant 140 or plug-in 145 on the device 105. If the web server 120 receives a positive response (i.e., indicating that a particular installation assistant 140 and/or plug-in 145 is installed on the device 105), the web server 120 could then send data intended for the plug-in 145, such as by employing a message tag, certificate, or other data recognizable to the plug-in 145 and signaling that the message is to be processed by the plug-in 145 and/or the installation assistant 140. The plug-in 145 could process these plug-in-supported-messages, for example, to invoke the installation assistant 140, route subsequent messages to the installation assistant 140 or the supported message itself to the installation assistant 140, or even perform certain authentication and authorization functions to certify the trustworthiness of the source of messages received by the device 105.

In some implementations, the plug-in 145 is designed to accept arbitrary messages from arbitrary sources, for example sets of installation instructions sent by arbitrary web servers 120, 125, 130, 135 offering the download of particular software products. This may be facilitated by providing the plug-in 145 with a fixed instruction set or vocabulary. Remote application and download devices 120, 125, 130, 135 would be responsible for formatting data sent to or through the plug-in so as to comport with this predefined plug-in vocabulary. If the arbitrary message sent to the plug-in 145 does not present data compatible with the plug-in vocabulary, the plug-in 145 could pass the message to a second component, such as a web browser 142 operating in concert with the plug-in 145, the installation assistant 140, or some other application on the device 105 capable of responsively processing the message. On the other hand, if the message employs plug-in vocabulary, enabling the plug-in to process the message, the plug-in would then be alerted that it is to handle further processing of this particular message.

FIGS. 1A and 1B also illustrate a remote update device 150. The update device 150 is capable of communicating with the device 105. Communication may be facilitated through the installation assistant 140, the plug-in 145, or both. The functions of the installation assistant 140 and the plug-in 145 can be integrated into a single software module. The update device 150 may also be capable of communicating with one or more devices attached to a network 110. In some implementations, the client device 105 facilitates communication with the update device 150 through the installation assistant 140. Other implementations may provide for the plug-in 145 to interface with the update device 150 on behalf of the client device 105. In implementations where the plug-in 145 interfaces with the update device 150, the plug-in 145 could function as a gate-keeper for installation instructions intended for the installation assistant 140. For example, the plug-in 145 could receive an installation request, which may include installation instructions, and forward the installation request to the update device 150. The plug-in 145 could operate so as to only forward the installation instructions to the installation assistant if a message returned by the update device 150 indicates that it is safe to pass the installation instructions to the installation assistant 140.

The update device 150 is capable of processing queries and other messages received from the client device 105 related to the installation of software products on the client device 105. For example, the update device 150 may receive a query from the client device 105 regarding the trustworthiness or accuracy of certain installation instructions received by the client device 105. As an example, installation instructions received by the device 105 may direct the installation assistant 140 to send a request to a certain URL associated with a web server 130 in order to download data files required for the installation of a certain software product on the device 105. Prior to sending this request and thereby potentially exposing the device 105 to a malicious site associated with the URL, the device 105 sends a query to the update device 150. The query may specifically request the update device to authenticate the URL. In other implementations, the query may simply consist of the device 105 forwarding verbatim installation instructions, including the URL pointer in question, for processing by the update device 150.

The update device may develop a response to the query by, for example, consulting a whitelist maintained by the update device 150 to see if the software product being offered for installation in conjunction with the installation instructions matches a URL stored as a trusted source for files associated with the installation of the software product. Alternatively or in addition, the update device could consult a blacklist, storing a list of forbidden sources and software products, or other databases capable of providing the data necessary to construct a responsive query reply message. A processor module 160 and a storage module 165 may be provided on the update device 150, whereby the storage module 165 may manage storage and maintenance of the whitelist or other databases. The processor module 160 could be responsible for processing the data comprising the query, calling information from the storage module 165, and building a response message destined for the client device 105. The processor module 160 may also execute logic instructions allowing the processor module 160 to route query responses generated by the update device 150 to the originating client device 105. After processing the query, the update device then responds to the client device 105, allowing the update device 150 to determine whether or not to proceed with the installation of the software product. In addition to validating the source of the installation instructions, the update device 150 may also parse the installation instructions and validate that the installation instructions have been previously approved, correspond to instructions expected from the particular source, or are otherwise considered to be safe.

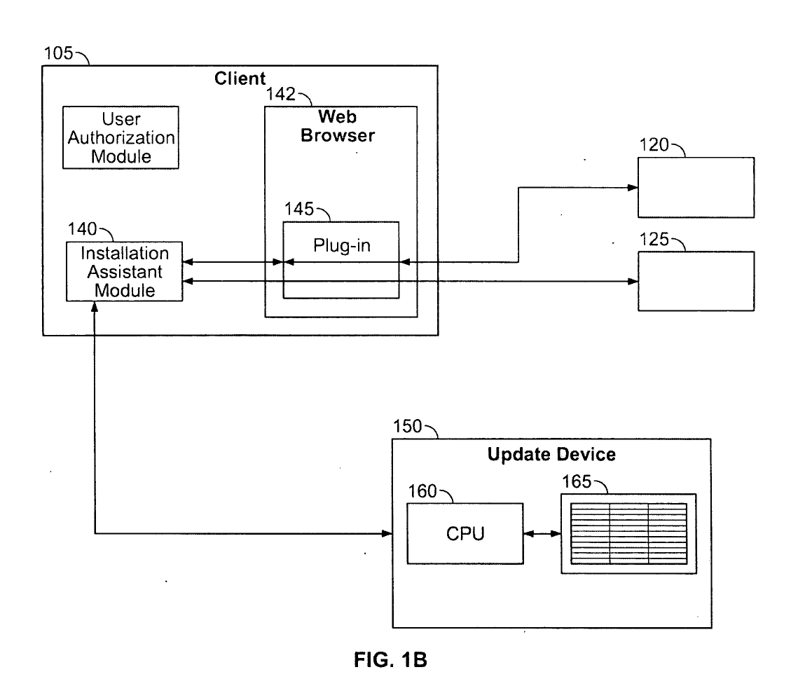

FIG. 2 illustrates a flow diagram illustrating the interaction of some of the components of system 100, including operations 200 capable of being carried out by the system 100 and its various potential components. In some implementations, operations illustrated beneath a heading corresponding to a particular system component are performed by that component.

In this particular example 200, installation instructions are sent 205 from one or more application servers to a client device and then received by the client device 105. The installation instructions are received 210 by an installation assistant plug-in installed on the device and linked to a browser application on the device. The plug-in routes 215 the instructions to an installation assistant module installed on the device that is responsible for installing one or more software products associated with received installation instructions. The plug-in may process the installation instructions prior to routing them to the installation assistant module, so that, for example, only a portion of the installation instructions are forwarded 220 to the installation assistant module. The plug-in, in some implementations, may send additional instructions to the installation assistant. For example, the additional instructions may indicate that certain authentication queries need to be made regarding the installation instructions before the installation instructions are executed by the installation assistant.

A query is sent 225 from the device to an update device to authenticate the received installation instructions. The update device then receives 230 the query and processes 235 it. After processing the query, the update device sends 240 a query response message to the client device. The query response, responsive to the subject matter of the query sent at 225, may indicate that installation instructions, or certain installation steps, are trustworthy and authorized for execution by the client device. The query sent at 225 and the query response returned at 240 may alternatively pertain to any query related to the installation of a software product on a client device. For example, the query may relate to checking whether installation of the software product is needed (i.e. whether the software product or an equivalent is already installed on the device), checking to see if an end-user license agreement for the software product needs to be accepted by a user of the device, and/or suggesting installation instruction modifications or alternate installation instructions for a given software product.

Once the query response is received 245 by the client device, the client device then executes 250 the installation instructions. Execution of the installation instructions 250 may proceed differently than originally set forth in the installation instructions sent at 205, if, for example, the query response resulted in modification or replacement of the installation instructions. In fact, if a query response indicates, for example, that the installation instructions received by the client device at 210 are not authentic or instruct the client device to access an unauthorized URL, the client device may respond to receipt of such a query response by refusing to execute the installation instructions received at 210.

In some implementations, execution of the installation instructions 250 by the client device proceed by requesting 255 files from an application data source, in this example, an outside web server. The outside web server may be distinct from the application server that sent the installation instructions at 205. The application data source receives 260 the request and transmits 265 the files to the client device. After receiving these data files, the client device uses the received data files to complete installation of the software product.

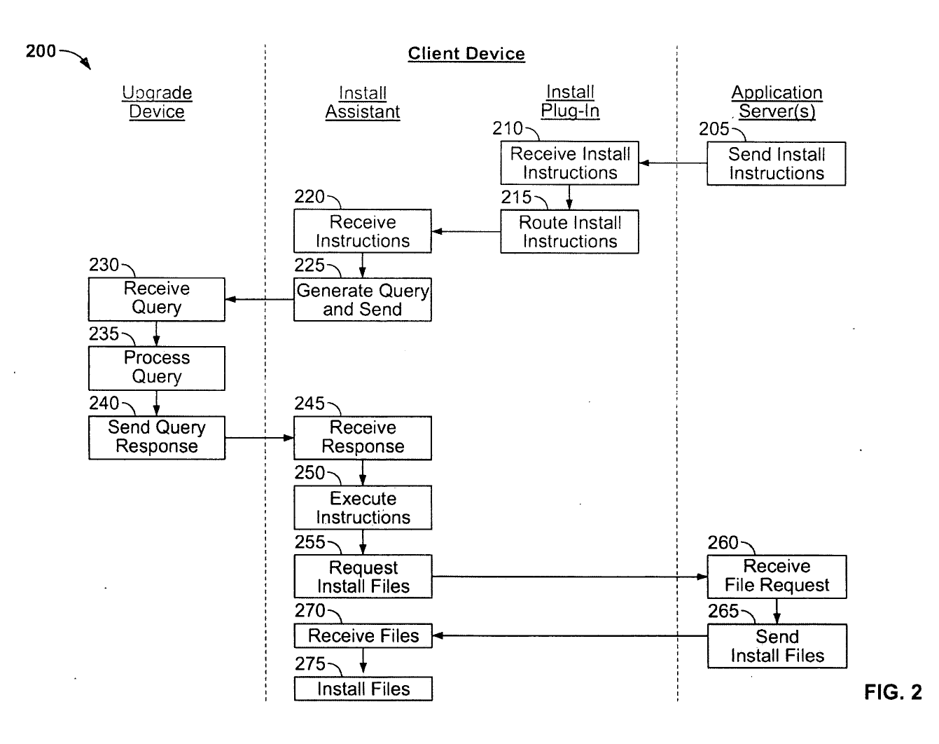

FIG. 3 illustrates one implementation of a process 300 for automatically installing a software product onto a device. First, a request to install a software product on a device is received 305. The request may comprise one or more instructions that are to be performed to install the software product on the device. The software product sought to be installed, together with the source of the software product are then identified 310. The identity of the software product and its source may be derived from the installation instructions themselves or other data transmitted in connection with the request to install a software product. The source may also be identified by capturing the web address or URL of the webpage from which the browser application receives the request to install a software product. The device may identify the name of the software product or some other data associated with the software product. Certain instruction steps contained in the installation instructions, for example, may serve to identify the software product, or perhaps also the source of the software product. For example, the installation instructions may direct the device to download certain data files by accessing a certain network address or URL. The name of this network address or URL could then be used to identify the software product and its source.

Upon identifying the software product and the source of the software product, the device transmits 315 a message communicating the identity of the software product and the source of the software product to a remote update device. This message could be generated and transmitted as an XML, HTML, or other formatted communication. The message could contain the explicit name of the software product and source, could name a network address or URL affiliated with the software product and source, forward installation instructions received with the request to install the software product, or simply forward the entire request to install to the remote update server. In any event, data comprising the message is capable of being processed by the remote update server to identify the software product and the source of the software product. In response to the transmission of this message, an authorization message is received 320 from the remote update device. The contents of this message communicate whether the source of the software product is authorized to provide the software product. If the message indicates that the source of the software product is authorized to provide the software product, the software product is then automatically installed 325 on the device.

Receipt of the authorization message 320 may, in some implementations, result in the installing 325 of the software product on the device if the authorization message, in fact, indicates that the source of the software product is authorized to provide the software product. Installation of the software product, in some implementations may proceed automatically, without further approval or intervention by the user of the device, upon receipt of the authorization message 320.

Automatically installing a software product allows users to streamline the process for adding software programs to their devices as well as update software applications already installed on their devices by omitting several installation steps, such as required prompts to the user and inputs from the user of the device. While prompts and inputs involving the user slow the installation process, they do allow the user to manage what is being installed on their devices and how. Automating this process, while streamlining the user experience, threatens to allow malicious software products to be unwittingly installed on the user's device. Among the benefits of the process 300, when employed with an automatic installation process, such as described generally above, the process 300 allows for the device to check the authenticity and security of software products being offered for installation on the device, and guard against the installation of unauthorized or otherwise malicious software products on the device. Such implementations would allow for the secure, automatic installation of software products without input from the user.

Alternatively, automatic installation of the software products could also take place after receiving an initial user authorization to install a software product. The user authorization could be received through a web browser, for example, by the user selecting a download program link on a website corresponding to the source of the software product (e.g., thereby implementing a one-click installation process). Other implementations may include a pop-up dialogue box asking the user to authorize installation of a certain software product before proceeding with the automatic installation of the software product.

If the authorization message received at 320 indicates that an installation request, installation instructions, software product, or a software product source are not authorized, the authorization message could be processed so as to deny automatic installation of the software product. In some implementations the authorization message could be processed so as to generate and transmit an error message to the source of the installation instructions or installation request. Additionally, a prompt could be displayed to a user indicating that automatic installation of the software product failed. Were automatic installation of the software product to fail, the user might then be offered installation of the software product through an alternative installation method. For example, the alternative installation method might require one or more user selections, indicating user authorization of the installation, acceptance of certain installation conditions, designating a memory address for installation of the software product, and/or setting certain user profiles and other parameters and preferences related to installation of the software product.

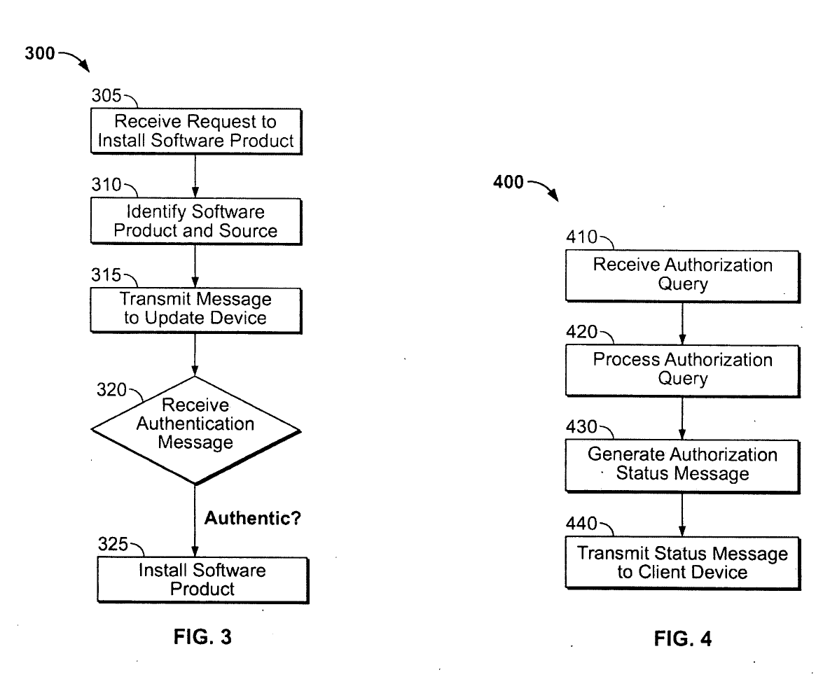

FIG. 4 illustrates one implementation of a process 400 for handling an authorization query by an update device. An authorization query is first received 410 from a client device in response to an installation request received from a remote download device. In some implementations, the authorization query includes data capable of being interpreted so as to identify an installation request and/or the source of the installation request. The authorization query is processed 420 to determine whether the remote download device is authorized to make the installation request, or, in other examples, to determine whether the installation request and underlying installation instructions contained in the installation request or sent in accordance with the installation request are authentic or trustworthy. Processing the authorization query may require consultation of data, for example a database comprising a whitelist of authorized software products and/or software product sources and/or a blacklist of unauthorized products and/or sources.

Upon processing the authorization query 420, an authorization status message is generated 430 and then transmitted 440 to the client device indicating the results of the update device's processing of the authorization query. For example, the status message may indicate that the software product source is authorized to provide a certain software product. The status message may indicate, in the alternative, that installation of the software product, according to the installation request, is unauthorized. The status message may indicate additional data relating to the installation of the software program, including whether an end-user license agreement associated with the software product needs to be accepted or updated. In some embodiments, this additional data may be unsolicited and automatically included in the status message returned to the client device.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions tangibly stored on a computer-readable storage device for execution by, or to control the operation of, data processing apparatus. In addition, the one or more computer program products can be tangibly encoded in a propagated signal, which is an artificially generated signal, e.g., a machine-generated electrical, optical, or electromagnetic signal, that is generated to encode information for transmission to suitable receiver apparatus for execution by a computer. The computer-readable storage device can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular implementations of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving a request to install a software product on a device;
identifying the software product and the source of the software product based on the request;
transmitting a message to a remote update device, the message comprising data identifying the software product and the source of the software product;
receiving an authorization message from the remote update device indicating whether the source of the software product is authorized to provide the software product; and
automatically installing the software product on the device if the authorization message indicates that the source of the software product is authorized to provide the software product.

2. The method of claim 1 further comprising transmitting an error message to the source of the software product if the authorization message indicates that the source of the software product is not authorized to provide the software product.

3. The method of claim 2 wherein the error message comprises data indicating that download of the program application failed.

4. The method of claim 2 wherein the request to install a software product on a device comprises installation instructions, the method further comprising receiving alternate installation instructions for installing a software product on a device from the source of the request to install a software product in response to the error message, the alternate installation instructions defining an alternate installation process.

5. The method of claim 4, wherein the alternate application installation process comprises displaying at least one prompt to a user and receiving at least one user selection in response to the at least one prompt.

6. The method of claim 1, further comprising transmitting a notification message to a source of the request to install a software product indicating that an installation assistant plug-in is installed on the device, wherein the request to install a software product is received in response to the notification message.

7. The method of claim 1, wherein the software product comprises an update of software previously installed on the device.

8. The method of claim 1, further comprising:
receiving a software license update message from the remote update device, wherein the software license update message indicates that an updated end user license agreement is needed prior to installation of the software product; and
receiving a user acceptance of the updated end user license agreement prior to automatically installing the software product.

9. The method of claim 1, further comprising receiving, from a user, an authorization to install the software product, wherein the authorization to install the software product is received from a user through a web browser on the device.

10. An article comprising a machine-readable medium storing instructions for causing computer processing apparatus to perform operations comprising:
identifying a software product and the source of the software product based on received installation instructions for installing the software product;
transmitting a message to a remote update device, the message comprising data identifying the software product and the source of the software product;
receiving an authorization message from the remote update device indicating whether the source of the software product is authorized to provide the software product; and
automatically installing the software product if the authorization message indicates that the source of the software product is authorized to provide the software product.

11. The article of claim 10, wherein the machine-readable medium further stores instructions for causing computer processing apparatus to perform operations comprising transmitting an error message to the source of the software product if the authorization message indicates that the source of the software product is not authorized to provide the software product.

12. The article of claim 10, wherein the machine-readable medium further stores instructions for causing computer processing apparatus to perform operations comprising automatically installing the software product in accordance with the installation instructions.

13. The article of claim 10, wherein the machine-readable medium further stores instructions for causing computer processing apparatus to perform operations comprising:
processing the received installation instructions to produce a processed installation instruction set;
detecting the received installation instructions received through a browser application to a module separate from the browser application; and
processing the received installation instructions to install the software product.

14. The article of claim 10, wherein the operations further comprise receiving permission to install a software product from a user through a user interface.

15. A system for automatically installing a software product comprising:
at least one client device;
at least one remote application server capable of transmitting installation instructions for installation of the software product to the at least one client device and capable of transmitting software product data to the at least one client device, wherein at least one other remote application server is responsible for transmitting software product data and comprises at least one remote download server; and
at least one update server capable of receiving an authorization query from the at least one client device, processing the authorization query, and transmitting an authorization message to the at least one client device.

16. The system of claim 15, wherein the at least one remote download server is distinct from the at least one remote application server responsible for transmitting the installation instructions.

17. The system of claim 15, wherein the at least one update server is further capable of processing the authorization query to determine whether the at least one remote download server is authorized to provide the software product to the client device.

18. The system of claim 15, wherein the at least one update server is further capable of transmitting an authorization message to the at least one client device indicating that the remote download server is authorized to provide the software product to the at least one client device.

19. The system of claim 15, wherein the at least one remote application server comprises a web server.

20. The system of claim 15, wherein the at least one client device comprises an installation assistant module, wherein the installation assistant module is capable of installing the software product on the at least one client device.

21. The system of claim 20, wherein the at least one client device comprises an installation assistant plug-in, wherein the installation assistant plug-in is capable of receiving and processing the installation instructions to produce a processed installation instruction set.

22. The system of claim 21, wherein the installation assistant module is capable of receiving and processing the processed installation instruction set.

23. The system of claim 21 wherein at least one of the installation assistant module or the installation assistant plug-in is adapted to operate with a web browser installed on the at least one client device.

24. The system of claim 15, wherein the at least one client device comprises a user authorization module, wherein the user authorization module is capable of receiving permission from a user to install the software product on the at least one client device.

25. A method comprising:
receiving an authentication query from a client device, wherein the authentication query is sent from the client device in response to an installation request received by the client device from a remote download device and the authentication query comprises at least installation request identification data;
processing the authentication query to determine whether the client device is authorized to accept the installation request; and
transmitting an authorization status message to the client device, wherein the authorization status message indicates whether the client device is authorized to accept the installation request.

26. The method of claim 25, wherein processing the authentication query comprises interpreting installation request identification data to identify at least one of the software product or the source of the software product.

27. The method of claim 25, wherein the source of the software product comprises a web server distinct from the remote download device.

28. The method of claim 25 further comprising consulting a database for an indication that the software product is authorized to be installed on the client device.

29. The method of claim 28 further comprising consulting a database for an indication that the source of the software product is authorized to provide at least one application file to the client device for use in installing the software product on the client device.

30. The method of claim 25, wherein the authentication query comprises installation instructions corresponding to the software product, wherein at least one of the software product or the source of the software product can be identified from the installation instructions.

31. The method of claim 30, further comprising determining whether the client device is authorized to execute the installation instructions.

32. The method of claim 30, wherein the installation instructions reference a network address corresponding to the source of the software product.

33. An article comprising a machine-readable medium storing instructions for causing computer processing apparatus to perform operations comprising:
receiving an authentication query from a client device, wherein the authentication query is sent from the client device in response to an installation request received by the client device from a remote download device and the authentication query comprises data identifying at least one of an installation request, the remote application device, a software product corresponding to the installation request, or a source of at least one installation file corresponding to the software product;
processing the authentication query to determine whether the client device is authorized to install the software product corresponding to the installation request; and
transmitting an authorization status message to the client device, wherein the authorization status message indicates whether the client device is authorized to install the software product.

34. The article of claim 33, the machine-readable medium further stores instructions for causing computer processing apparatus to perform operations comprising:
identifying whether a software license update is associated with the software product; and
transmitting software license update data to the client device.

35. The article of claim 33, wherein processing the authentication query comprises:
identifying the source of at least one installation file corresponding to the software product;
identifying the software product; and
determining whether the source of at least one installation file is authorized to provide at least one file corresponding to the software product to the client device.

36. The article of claim 35, wherein processing the authentication query further comprises:
consulting a list of authorized installation file sources for the identification of the source of at least one installation file corresponding to the software product; and
generating an authorization status message indicating that the source is authorized to provide at least one installation file corresponding to the software product to the client device if the source is identified on the list of authorized installation file sources.

37. The article of claim 33, wherein processing the authentication query comprises:
identifying the remote application device;
analyzing a received installation request; and
determining whether the remote application device is authorized to provide the received installation request to the client device.

38. The article of claim 37, wherein processing the authentication query further comprises:
consulting a database for the identification of the s remote application device; and
consulting the database to verify that the remote application device is authorized to provide a software product corresponding to the received installation request.
